(19) United States
(12) Patent Application Publication
(10) Pub. No.: US 2018/0250896 A1
(43) Pub. Date: Sep. 6, 2018

(54) MANUFACTURING METHOD AND MANUFACTURING APPARATUS FOR SILICONE RUBBER MOLDED BODY

(71) Applicant: Konica Minolta, Inc., Tokyo (JP)

(72) Inventors: Yoshiyasu Matsumoto, Tokyo (JP); Hiroyuki Yasukawa, Tokyo (JP); Hirofumi Koga, Tokyo (JP)

(21) Appl. No.: 15/908,054

(22) Filed: Feb. 28, 2018

(30) Foreign Application Priority Data
Mar. 2, 2017 (JP) 2017-039524

(51) Int. Cl. B29C 71/02

(52) U.S. Cl. CPC B29C 71/02; B29K 2683/00

(57) ABSTRACT

A manufacturing method for a silicone rubber molded body that is to be used in an electrophotographic image forming apparatus includes a heating process of a precursor of a silicone rubber molded body. The heating process includes heating the precursor of a silicone rubber molded body and externally introducing an environmental gas and discharging the environmental gas to outside, to reduce an amount of a low molecular weight compound remaining in the precursor of a silicone rubber molded body.

### BACKGROUND

### 1. Technological Field

The present invention relates to a manufacturing method and a manufacturing apparatus for a silicone rubber molded body. More specifically, the present invention relates to a manufacturing method and the like for a silicone rubber molded body, capable of reducing an amount of a low molecular weight compound remaining in silicone rubber, to reduce an amount of a low molecular weight compound to be volatilized in use as a product.

### 2. Description of the Related Art

In an electrophotographic image forming apparatus (hereinafter also referred to as an “image forming apparatus”), a silicone rubber molded body is widely used as a fixing roller.

Conventionally, in manufacturing of this silicone rubber molded body, when dust, dirt, or the like is present in a furnace such as a heating chamber in curing a silicone rubber precursor of the surface layer, there has been a problem that the silicone rubber precursor is adhered with dust, dirt, or the like before being cured, deteriorating quality. This requires periodical cleaning of an inside of the furnace, but it is not possible to perform the cleaning with the inside of the furnace heated, causing reduction of production efficiency.

To solve this problem, in a technique disclosed in JP H9-178353, a manufacturing apparatus for a silicone rubber molded body has a blowing mechanism, in order to allow a uniform temperature control inside a thermostatic chamber (heating chamber) in manufacturing a fixing roller, which is a silicone rubber molded body. In addition, JP H9-178353 discloses that a mechanism is provided that removes dust and dirt from outside air by using a filter, for cleaning outside air.

In the technique disclosed in JP H9-178353, the heated atmosphere is evenly applied to a surface of the silicone rubber molded body to uniformly heat. This causes uniform curing of silicone rubber of a surface layer, thereby achieving manufacture of a silicone rubber molded body having silicone rubber with uniform hardness. In addition, since this technique includes a mechanism that removes dust and dirt from outside, this technique also achieves suppression of contamination of the surface of the silicone rubber molded body.

On the other hand, it has been pointed out in recent years that a low molecular weight compound such as low molecular weight siloxane is volatilized from the silicone rubber of the fixing roller, and discharged from an image forming apparatus.

A problem has been reported where this low molecular weight compound contaminates an environment inside the image forming apparatus, and deposits to electronic parts and the like to cause contact failure. In addition, a problem is also reported where a volatilized low molecular weight compound becomes particles to contaminate inside the image forming apparatus.

In the related art (e.g., see JP H9-178353), although an operation has been performed for agitating atmosphere in the heating chamber and for allowing uniform heating of a precursor of a silicone rubber molded body, an idea has not been found for positively externally introducing an environmental gas and removing volatile substances such as low molecular weight compounds contained in the environmental gas in the heating chamber.

This seems to be because the heating chamber is intended for heating. That is, it has been intended to smoothly perform heat exchange by circulating, within the heating chamber, the environmental gas in the heating chamber, and effectively bringing the heated air into collision with the precursor of a silicone rubber molded body, thereby to promote the curing reaction of the silicone rubber and obtain desired physical property values of rubber such as hardness, at an early stage.

Therefore, the problem reported above has not been solved even with the use of the silicone rubber molded body having the surface suppressed with contamination by using the technique disclosed in JP H9-178353.

### SUMMARY

The present invention has been made in view of the above problems and circumstances, and it is an object of the present invention to provide a manufacturing method and the like for a silicone rubber molded body, capable of reducing an amount of a low molecular weight compound remaining in silicone rubber, to reduce an amount of a low molecular weight compound to be volatilized in use as a product.

In order to solve the problem described above, in the course of examination of the cause and the like of the above problems, the present inventor has found that, by introducing a mechanism that positively introduces outside air as the environmental gas in the heating chamber, a silicone rubber molded body with a reduced amount of a low molecular weight compound remaining in silicone rubber, and with a reduced amount of a low molecular weight compound to be volatilized in use as a product can be manufactured, and has achieved the present invention.

That is, the problems described above are solved by the following means.

To achieve at least one of the abovementioned objects, according to an aspect of the present invention, there is provided a manufacturing method for a silicone rubber molded body that is to be used in an electrophotographic image forming apparatus, the manufacturing method including:

a heating process of a precursor of a silicone rubber molded body, wherein

the heating process includes heating the precursor of a silicone rubber molded body and externally introducing an environmental gas and discharging the environmental gas to outside, to reduce an amount of a low molecular weight compound remaining in the precursor of a silicone rubber molded body.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, and wherein:

FIG. 1 is a detailed view of a main part, showing an example of a manufacturing apparatus for a silicone rubber molded body according to the present invention;

FIG. 2 is a view showing a schematic configuration of an example of a silicone rubber molded body according to the present invention;

FIG. 3 is an overall perspective view showing an example of the manufacturing apparatus for a silicone rubber molded body according to the present invention;

FIG. 4 is an overall side view of the manufacturing apparatus for a silicone rubber molded body shown in FIGS. 1 and 3; and

FIG. 5 is a view showing a schematic configuration of an electrophotographic image forming apparatus according to the present invention.

### DETAILED DESCRIPTION OF EMBODIMENTS

Hereinafter, one or more embodiments of the present invention will be described with reference to the drawings. However, the scope of the invention is not limited to the disclosed embodiments.

Although an exertion mechanism or an action mechanism of the effect of the present invention has not been clarified, it is considered as follows.

Traditionally, treatment in a heating chamber at a time of producing a silicone rubber molded body has been performed with a purpose of promoting rubber crosslinking of a rubber raw material to be molded with a low molecular weight monomer or the like. From a precursor of a silicone rubber molded body heated in a heating chamber, as the crosslinking proceeds, a low molecular weight compound contained in the rubber raw material volatilizes and gradually diffuses into an environmental gas in the heating chamber. Therefore, ideally, the low molecular weight compound is also to be removed by the heating, and is not to remain in the silicone rubber molded body. However, the inventor of the present invention has found that, in practice, the low molecular weight compound may partially remain in the silicone rubber molded body.

Conventionally, from the viewpoint of thermal efficiency, there has been provided a mechanism that inhibits diffusion of heat (atmosphere) inside a chamber to outside as much as possible in an actual situation.

However, if the inside of the heating chamber is isolated from outside and hermetically sealed, an amount of a low molecular weight compound exceeds an amount that can be contained in the environmental gas in the heating chamber, causing a problem that the diffusion no longer occurs beyond that from the precursor of a silicone rubber molded body into the environmental gas. When cooling is performed under such a situation, the low molecular weight compound remains inside the silicone rubber molded body. The inventor of the present invention has found that, when there is used such a silicone rubber molded body remained with the low molecular weight compound inside, the low molecular weight compound volatilizes and deposits to the surroundings, causing problems such as the contact failure described above. Therefore, it has been found that remaining of a low molecular weight compound inside the silicone rubber molded body can be suppressed by positively introducing fresh environmental gas not containing a low molecular weight compound, at a time of manufacture. In this respect, the present invention is different from the prior art.

Specifically, in the present invention, in a heating process, an environmental gas is externally introduced and discharged to outside. That is, gas around a precursor of a silicone rubber molded body (an environmental gas in a chamber) is externally introduced, and the environmental gas is discharged to outside (hereinafter also referred to as “introducing and discharging environmental gas”, “external introduction and discharge of environmental gas”, “introduction and discharge of environmental gas”, or the like). This results in reducing an amount of a low molecular weight compound contained in silicone rubber, thereby allowing reduction of an amount of a low molecular weight compound to be volatilized from the silicone rubber.

In the present invention, the term “environmental gas” is used. In the present invention, this refers to gas that is present under an environment capable of coming into contact with a precursor of a silicone rubber molded body, in a heating process of the precursor of a silicone rubber molded body. Specifically, as will be described later, the “environmental gas” refers to gas to be present in the heating chamber that performs heating of the precursor of a silicone rubber molded body.

The “silicone rubber molded body” used in the present invention refers to a silicone rubber composition subjected to a heat treatment in the above-mentioned heating process, and the “precursor of a silicone rubber molded body” is a silicone rubber composition before being subjected to the heat treatment of the above-mentioned heating process. For example, a silicone rubber mixture, which is silicone rubber added with a curing agent or an additive such as microballoon described in the Examples described later, corresponds to the precursor of a silicone rubber molded body since the silicone rubber mixture is before being subjected to the heat treatment.

In particular, the silicone rubber molded body manufactured by the manufacturing method of the present invention can exhibit more effects when applied to a fixing unit and a member used around the fixing unit of an electrophotographic image forming apparatus. Even among them, when adopted as a fixing roller or a fixing belt, the silicone rubber molded body is more effective.

An electrophotographic image forming apparatus usually has a process of fixing a toner image on paper. In the fixing process, the toner image and the paper are subjected to treatment of heating and pressing, thereby to fix the toner image on the paper. During this heating, the fixing unit itself including the silicone rubber molded body is also heated. Therefore, when a silicone rubber molded body is adopted as a fixing unit and a member used around the fixing unit, it is required to assume the use under high temperature. That is, using the silicone rubber molded body as a fixing roller involves, for example, a process of promoting volatilization of a low molecular weight compound by heating or the like. Therefore, when the conventional silicone rubber molded body is adopted as a fixing unit and a member (e.g., fixing roller) used around the fixing unit, the low molecular weight compound may volatilize and contaminate inside the image device as described above. However, in the silicone rubber molded body manufactured by the manufacturing method of the present invention, since the amount of the low molecular weight compound generated in heating is reduced, the silicone rubber molded body can be suitably adopted as a fixing unit and a member used around the fixing unit.

The manufacturing method for a silicone rubber molded body of the present invention is a manufacturing method for a silicone rubber molded body to be used in an electrophotographic image forming apparatus. The method features including a heating process of a precursor of a silicone rubber molded body, and the heating process includes heating the precursor of a silicone rubber molded body and externally introducing an environmental gas and discharging the environmental gas to outside, to reduce an amount of a low molecular weight compound remaining in the precursor of a silicone rubber molded body. This feature is a technical feature common or corresponding to the invention according to each claim. This can provide the present invention with an effect of being able to provide a manufacturing method and the like for a silicone rubber molded body with a reduced amount of a low molecular weight compound remaining in silicone rubber, and with a reduced amount of a low molecular weight compound to be volatilized in use as a product.

While the present invention is to reduce an amount of a low molecular weight compound remaining in the silicone rubber molded body, the low molecular weight compound referred to in the present invention includes, for example, compounds having a weight average molecular weight of 2000 or less as described below when specified by molecular weight.

Further, for a content of a low molecular weight compound of the silicone rubber molded body formed through a heating process, it is confirmed that the effect is exhibited when the content is less than 1.5 mass % in the present invention, as described in Examples described later, for example. However, the present invention is not limited to this. It is sufficient that the silicone rubber molded body produced through the process defined in the present invention can stably form an image without causing contact failure or the like caused by a residual low molecular weight compound.

In an embodiment of the present invention, it is desirable that, in the heating process, after heating the precursor of a silicone rubber molded body in a heating chamber, the environmental gas is externally introduced and discharged to outside, in the heating chamber. Even such an aspect can provide the effect of the present invention.

As an embodiment of the present invention, it is desirable that, in the heating process, after heating the precursor of a silicone rubber molded body in a heating chamber, and after moving the heated precursor of a silicone rubber molded body from the heating chamber to a gas introducing chamber, the environmental gas is externally introduced into the gas introducing chamber and discharged to outside. This can even more properly exert the effect of the present invention.

In an embodiment of the present invention, when a total volume of the precursor of a silicone rubber molded body is defined as V (m³), a speed for externally introducing the environmental gas and discharging the environmental gas to outside is desirably within a range of 0.3×V to 100×V (m³/min). This can reduce an amount of a low molecular weight compound contained in the silicone rubber molded body more effectively, and can provide the manufacturing method with high thermal efficiency.

In an embodiment of the present invention, the silicone rubber molded body may be adopted as a fixing roller or a fixing belt to be used in a fixing unit. Even when adopted as the fixing roller or the fixing belt, which is expected to be used at high temperature, it is possible to reduce an amount of a low molecular weight compound generated in heating.

In an embodiment of the present invention, the environmental gas externally introduced is desirably compressed air or dry nitrogen having a moisture content of 5 mass % or less. This can suppress hydrolysis of the silicone rubber, involved in contact with moisture.

In an embodiment of the present invention, it is desirable to blow the environmental gas externally introduced, at an angle of 45 degrees or more with respect to a longitudinal direction of the precursor of a silicone rubber molded body. This can further reduce an amount of a low molecular weight compound to be volatilized in use as a product.

In an embodiment of the present invention, a value (V/T) of a ratio of the total volume V (m³) of the precursor of a silicone rubber molded body to a capacity T (m³) of the chamber into and from which the environmental gas is externally introduced and discharged to outside, is desirably within a range of 0.02 to 0.70. This can reduce an amount of a low molecular weight compound contained in the silicone rubber molded body more effectively, and can reduce a production cost.

In an embodiment of the present invention, it is desirable that the silicone rubber molded body is a rubber roller obtained by coating an outer layer of a core metal with silicone rubber, and Asker C hardness of the silicone rubber on the core metal is within a range of 30 to 60°. This gives appropriate elasticity to the silicone rubber molded body and can improve adhesion to paper, allowing heat and pressure to be applied uniformly and effectively.

A manufacturing apparatus for a silicone rubber molded body, capable of adopting the manufacturing method for a silicone rubber molded body of the present invention may include a manufacturing apparatus having a heating chamber that heats a precursor of a silicone rubber molded body, in which the heating chamber has a unit that introduces an environmental gas from outside the manufacturing apparatus for a silicone rubber molded body and discharges the environmental gas to outside. Even such an aspect can suitably exert the effect of the present invention.

Further, a manufacturing apparatus for a silicone rubber molded body, capable of adopting the manufacturing method for a silicone rubber molded body of the present invention may include a manufacturing apparatus having a heating chamber and a gas introducing chamber into which a precursor of a silicone rubber molded body is transferred from the heating chamber, in which the heating chamber heats the precursor of a silicone rubber molded body, and the gas introducing chamber has a unit that externally introduces an environmental gas from outside the manufacturing apparatus for a silicone rubber molded body and discharges the environmental gas to outside. Such an aspect can further suitably exert the effect of the present invention.

Hereinafter, the present invention, its constituent elements, and embodiments and aspects for carrying out the present invention will be described in detail. In the present application, “to” is used to include numerical values described before and after “to” as a lower limit value and an upper limit value.

In the present invention, the low molecular weight compound refers mainly to cyclic dimethyl polysiloxane and low molecular weight dimethyl polysiloxane. However, the low molecular weight compound is not limited to these, but may be a compound having a weight average molecular weight of 2,000 or less, for example.

The low molecular weight compound remaining in the precursor of a silicone rubber molded body is synonymous with the low molecular weight compound contained in the finished silicone rubber molded body.

<<Outline of Manufacturing Method for Silicone Rubber Molded Body of the Present Invention>>

The manufacturing method for a silicone rubber molded body of the present invention is a manufacturing method for a silicone rubber molded body to be used in an electrophotographic image forming apparatus. The method features including a heating process of a precursor of a silicone rubber molded body, and the heating process includes heating the precursor of a silicone rubber molded body and externally introducing an environmental gas and discharging the environmental gas to outside, to reduce an amount of a low molecular weight compound remaining in the precursor of a silicone rubber molded body.

In other words, the manufacturing method for a silicone rubber molded body of the present invention externally introduces an environmental gas and discharges the environmental gas to outside when heating. A heating method is not particularly limited, and its details will be described later. In general, the precursor of a silicone rubber molded body stored inside the chamber is heated by externally heating the chamber. A form of heating may be a batch type or continuous type. For example, a batch type may be such a form that the precursor of a silicone rubber molded body is left to stand in the chamber and taken out after being heated for a predetermined time. Further, a continuous type may be such a form that a tubular heating chamber is used, and the precursor of a silicone rubber molded body is heated for a predetermined time while moving inside the heating chamber.

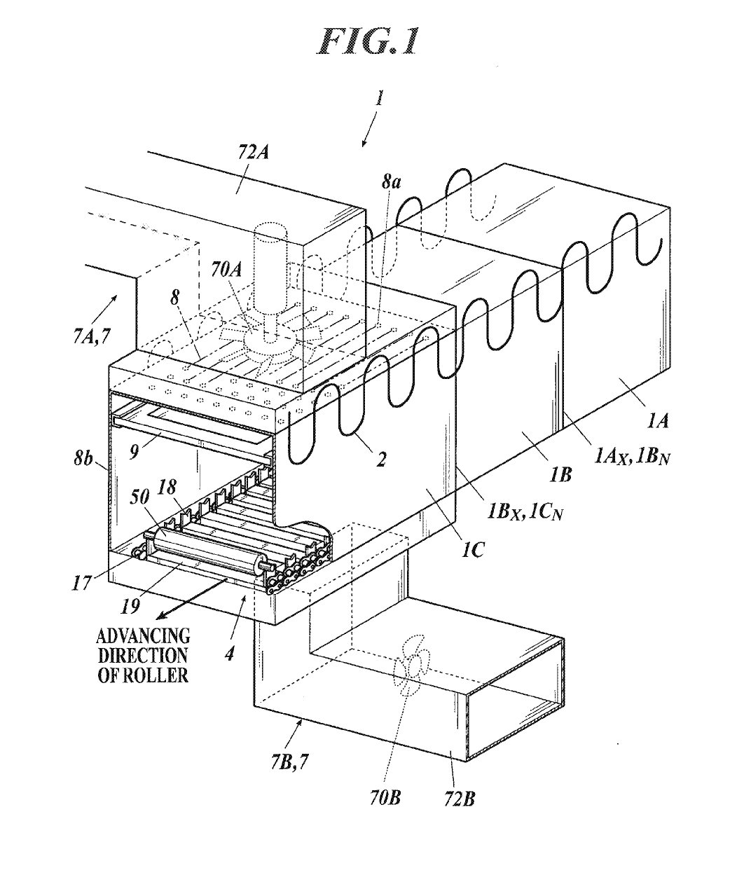

In the present invention, as shown in FIG. 1 to be described later, a continuous type process is desirable. In this case, it is desirable to externally introduce an environmental gas and discharge the environmental gas to outside, after heating of the precursor of a silicone rubber molded body for crosslinking a rubber raw material. This can suppress a decrease in temperature inside the chamber due to the introduction of the environmental gas, and thereby can efficiently apply heat energy for crosslinking the rubber raw material, being desirable from the viewpoint of the thermal efficiency.

In the manufacturing method for a silicone rubber molded body of the present invention, there is no particular limitation other than the heating process of the precursor of a silicone rubber molded body, and a silicone rubber molded body can be manufactured by using a publicly known method.

Hereinafter, a specific example of a process before the heating process of the present invention, that is, a forming method of a precursor of a silicone rubber molded body will be described.

First, a curing agent (e.g., CAT-1602, manufactured by Shin-Etsu Chemical Co., Ltd.) is added to a rubber raw material to be molded with a low molecular weight monomer or the like, and thoroughly mixed with an agitator to obtain a first mixture.

Next, for example, expanded thermally-expandable microcapsules (e.g., Expancel 461, which is a microballoon manufactured by Akzo Nobel N.V) are added to the first mixture and mixed with an agitator to obtain a second mixture containing the thermally-expandable microcapsules.

Next, for example, a core metal made of aluminum and a paper tube thicker than the core metal are layered with the core metal centered. Then, after the first mixture (not containing thermally-expandable microcapsules) is poured into between the paper tube and the core metal and heated to complete curing, the paper tube is removed, and a solid rubber layer is formed.

Thereafter, a second mixture (including thermally-expandable microcapsules) is applied to the solid rubber layer to form a precursor of a silicone rubber molded body.

Next, this precursor of a silicone rubber molded body becomes a silicone rubber molded body through the heating process according to the present invention.

It is noted that the forming method of the precursor of a silicone rubber molded body is not limited to the above. For example, coating liquid containing a rubber raw material may be applied directly onto a core metal to form a precursor of a silicone rubber molded body.

[Heating Process]

The heating process according to the present invention includes heating the precursor of a silicone rubber molded body and externally introducing and discharging an environmental gas, thereby to reduce an amount of a low molecular weight compound remaining in the precursor of a silicone rubber molded body.

The heating process is not particularly limited as long as it is as described above, but the following two aspects can be mentioned as specific examples.

First, a specific example of an aspect of the heating process includes heating the precursor of a silicone rubber molded body in the heating chamber, and then in the heating chamber, externally introducing and discharging the environmental gas.

Another specific example of an aspect of the heating process includes, in the heating process, heating the precursor of a silicone rubber molded body in the heating chamber, then moving the heated precursor of a silicone rubber molded body from the heating chamber to a gas introducing chamber, and after that, externally introducing the environmental gas into the gas introducing chamber and discharging.

As described above, it is considered that a higher effect can be achieved by separating the heating chamber and the gas introducing chamber for the environmental gas to be externally introduced and discharged.

In order to volatilize a low molecular weight compound contained in the silicone rubber as in the above two aspects, it is desirable to firstly heat the entire precursor of a silicone rubber molded body uniformly to crosslink, and then externally introduce and discharge the environmental gas. Thereby, the silicone rubber is cured (vulcanized) by heating, and thereafter the low molecular weight compound contained in the atmosphere can be discharged out of the system by exchanging the atmosphere, to enable further removal of the low molecular weight compound.

During the external introduction and discharge of the environmental gas, heating the precursor of a silicone rubber molded body is desirable since this can further reduce the amount of the low molecular weight compound remaining in the silicone rubber.

Further, after the entire precursor of a silicone rubber molded body is uniformly heated to be crosslinked, the precursor of a silicone rubber molded body may be further heated for a certain period of time as aging. In the heating process according to the present invention, the environmental gas may be externally introduced and discharged after undergoing of this aging. Such aging allows further volatilization of the low molecular siloxane remaining in the silicone rubber, thereby to allow further reduction of an amount of a low molecular weight compound remaining in the silicone rubber, enabling reduction of an amount of a low molecular weight compound to be volatilized in use as a product.

<Environmental Gas>

In the present invention, the environmental gas refers to gas in the chamber. Specifically, for example, the environmental gas refers to gas in the heating chamber or gas in the gas introducing chamber. It is noted that, in the present invention, “external introduction and discharge of environmental gas” means introducing normal air such as atmosphere, or gas such as dry nitrogen, as an environmental gas from outside the manufacturing apparatus for a silicone rubber molded body, and then discharging the environmental gas in the manufacturing apparatus for a silicone rubber molded body.

Introduction and discharge of the environmental gas are performed to remove a low molecular weight compound that has been heated and volatilized. Therefore, from the viewpoint of thermal efficiency, introduction and discharge of the environmental gas are desirably performed after heating of the precursor of a silicone rubber molded body. When a total volume of the precursor of a silicone rubber molded body is defined as V (m³), a speed for externally introducing and discharging the environmental gas is desirably within a range of 0.3×V to 100×V (m³/min).

When the speed for externally introducing and discharging the environmental gas is 0.3×V (m³/min) or more, the volatilized low molecular weight compound does not stay in the chamber. This inhibits re-deposition of the low molecular weight compound to the silicone rubber molded body, enabling effective reduction of an amount of a low molecular weight compound contained in the silicone rubber molded body.

Further, when the speed for externally introducing and discharging the environmental gas is 100×V (m³/min) or less, the precursor of a silicone rubber molded body can be effectively heated, enabling the manufacturing method with high thermal efficiency. A flow rate of the introduced atmosphere can be observed with a general flowmeter. For example, the flow rate can be observed with a flowmeter manufactured by Nippon Flow Cell (FLT-H) or the like.

The total volume V (m³) of the precursor of a silicone rubber molded body is a volume of all the precursors of a silicone rubber molded body present in the chamber into and from which the environmental gas is externally introduced and discharged to outside.

Note that the gas externally introduced is desirably an inert gas, and the concentration of siloxane is desirably 5 mass % or less. This makes it possible to provide a manufacturing method for a silicone rubber molded body, capable of more efficiently reducing an amount of a low molecular weight compound remaining in silicone rubber, enabling further reduction of an amount of a low molecular weight compound to be volatilized in use as a product.

Further, the environmental gas externally introduced is not particularly limited to that described above, and various kinds of environmental gases can be used. However, for the following reason, compressed air having a moisture content of 5 mass % or less (hereinafter also referred to as “compressed dry air”) or dry nitrogen is particularly desirable. Among these, considering the cost, using compressed dry air is suitable. It is noted that such a method of supplying gas is not particularly limited, and may be a publicly known method. For example, the gas may be supplied from compressed air produced by a device equipped with a mechanism to remove moisture, or a nitrogen cylinder.

A lower moisture content of the environmental gas externally introduced is more desirable since hydrolysis of the silicone rubber due to contact with moisture can also be suppressed. That is, it is desirable that the environmental gas to be introduced is dried as much as possible, and the moisture content of 5 mass % or less is particularly desirable. In addition, it is desirable that the environmental gas externally introduced can contain a low molecular weight compound as much as possible, and inexpensive gases are desirable since the production cost can be reduced.

For a method of measuring a moisture content of the environmental gas, the measurement can be performed by observing a dew point, for example XPDM type manufactured by Mitsubishi Chemical Analytech, Co., Ltd. can be used.

The environmental gas externally introduced is also desirable from the viewpoint of equalizing the temperature distribution in the chamber. Moreover, it is desirable to blow at an angle of 45 degrees or more with respect to a longitudinal direction of the precursor of a silicone rubber molded body, and more desirable to blow at an angle of 70 degrees or more. This can effectively remove a low molecular weight compound volatilized from the precursor of a silicone rubber molded body, resulting in further reduction of an amount of a low molecular weight compound remaining in the silicone rubber, and enabling further reduction of an amount of a low molecular weight compound to be volatilized in use as a product. This seems to be because blowing at the angle as described above removes the low molecular weight compound retained around a surface of the precursor of a silicone rubber molded body, and can promote replacement of the environmental gas around the surface with an environmental gas not containing a low molecular weight compound.

Further, the environmental gas in the chamber is required to flow even during volatilization of the low molecular weight compound present inside the precursor of a silicone rubber molded body, and there is desirably a flow in a vertical direction with respect to a longitudinal direction of the precursor of a silicone rubber molded body. When the airflow inside the chamber is a laminar flow, uniformity of the atmosphere can be suitably maintained, enabling more effective reduction of an amount of a low molecular weight compound with the introduction and discharge of the environmental gas.

<Silicone Rubber Molded Body>

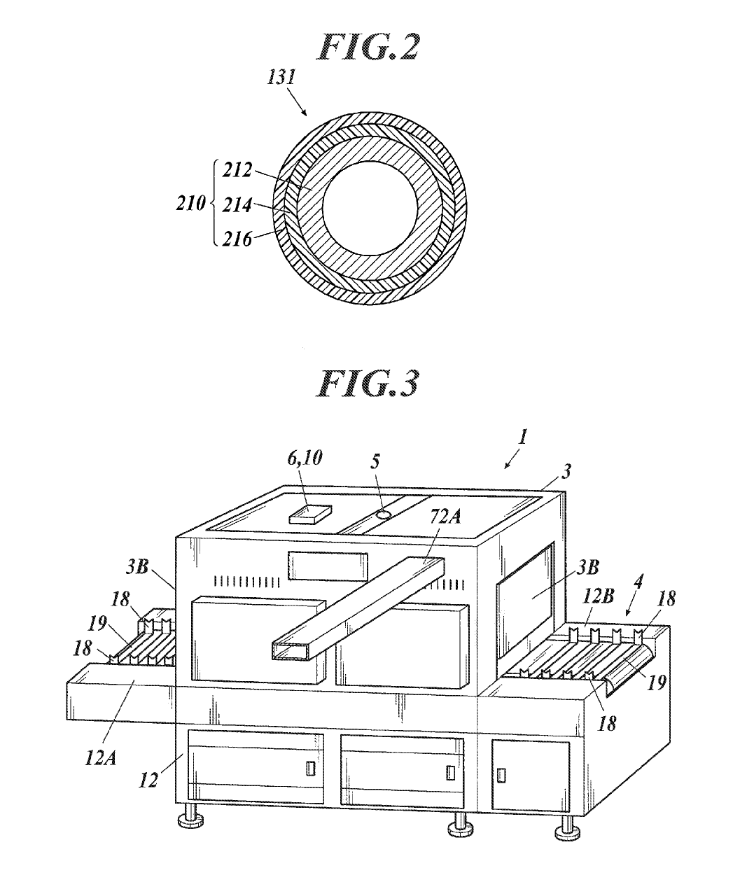

The silicone rubber molded body according to the present invention is not particularly limited as long as it is formed by molding a silicone rubber. For example, a cylindrical roller having a silicone rubber on its surface layer as shown in FIG. 2 may be mentioned.

A specific example of a silicone rubber molded body 210 according to the present invention includes a pressurizing roller 131 described later, which is desirably a rubber roller formed by a cylindrical core metal 212 and a silicone rubber as a solid rubber layer covering an outer layer of the core metal 212. For hardness of the silicone rubber on the core metal, Asker C hardness within a range of 30 to 60° is desirable. This can form a proper nip, and can effectively apply heat and pressure to a paper and toner. It is noted that the silicone rubber molded body may have, but not limited to, a three-layer structure with a sponge rubber layer 216 provided so as to cover an outer peripheral surface of a solid rubber layer 214. The solid rubber layer 214 and the sponge rubber layer 216 are made of silicone rubber. Here, a roller main body including the above (the three-layered structure of the core metal 212, the solid rubber layer 214, and the sponge rubber layer 216) is named a silicone rubber molded body 210. The silicone rubber molded body 210 is an example of a silicone rubber molded body according to the present invention.

Meanwhile, the Asker C hardness according to the present invention refers to a hardness at 25° C. measured with an Asker C hardness tester conforming to SRIS 0101.

The core metal 212 is made of a metal material such as aluminum, iron, or SUS.

Here, a thickness of the core metal 212 is about 0.1 to 5 mm, but in consideration of weight reduction and warm-up time, about 0.1 to 1.5 mm is more desirable.

Here, a diameter of the core metal 212 is set to about 10 to 50 mm.

As described above, the solid rubber layer 214 and the sponge rubber layer 216 are made of silicone rubber.

The silicone rubber has heat resistance against the fixing temperature above, and elasticity for securing a size (length of a nip portion) of an area where paper 90 is pressed.

The solid rubber layer 214 is a solid hard layer. A thickness of the solid rubber layer 214 is desirably within a range of 5 to 10 mm, and is set to about 7 to 8 mm in this case.

On the other hand, the sponge rubber layer 216 is a sponge-like soft layer containing numerous microballoons. A thickness of the sponge rubber layer 216 is desirably within a range of 5 to 100 μm, and is set to about 80 to 90 μm in this case.

Further, a specific usage example of the silicone rubber molded body includes a fixing roller or a fixing belt used for a fixing unit. Even applying the silicone rubber molded body as the fixing roller or the fixing belt is desirable, since it is possible to reduce an amount of a low molecular weight compound remaining in the silicone rubber, to reduce an amount of a low molecular weight compound to be volatilized in use as a product, according to the manufacturing method for a silicone rubber molded body of the present invention.

The term “precursor of a silicone rubber molded body” refers to a state of a silicone rubber molded body before curing of a rubber raw material to be molded with a low molecular weight monomer or the like.

<<Manufacturing Apparatus for Silicone Rubber Molded Body>>

Hereinafter, with reference to FIGS. 1 and 3, a manufacturing method for a silicone rubber molded body according to the present invention will be specifically described, with a manufacturing apparatus 1 for a silicone rubber molded body as an example.

FIG. 1 is a detailed view of a main part, showing an example of the manufacturing apparatus 1 for a silicone rubber molded body (hereinafter, also simply referred to as a “manufacturing apparatus”) according to the present invention. FIG. 3 is an overall perspective view showing an example of the manufacturing apparatus for a silicone rubber molded body according to the present invention.

The manufacturing apparatus 1 for a silicone rubber molded body has: a heating chamber 1A; and a gas introducing chamber 1C to which a precursor of a silicone rubber molded body (hereinafter, also simply referred to as a “roller” for simplification) 50 is transferred from the heating chamber 1A. The heating chamber 1A heats the precursor of a silicone rubber molded body, and the gas introducing chamber 1C has a unit 7 that introduces environmental gas from outside the manufacturing apparatus 1 for a silicone rubber molded body and discharges.

Additionally, the manufacturing apparatus 1 for a silicone rubber molded body has an aging chamber 1B between the heating chamber 1A and the gas introducing chamber 1C.

This aging chamber 1B is connected to be capable of transferring the precursor of a silicone rubber molded body from the heating chamber 1A to the gas introducing chamber 1C.

The heating chamber 1A, the aging chamber 1B, and the gas introducing chamber 1C have a transfer unit 4 inside. The precursor 50 of the silicone rubber molded body is transferred by this transfer unit 4 from the heating chamber 1A to the aging chamber 1B and the gas introducing chamber 1C, through an inside of each chamber.

<Heating Chamber>

In the heating chamber 1A, a heating process of the precursor of a silicone rubber molded body is performed. This causes curing of silicone rubber of the precursor of a silicone rubber molded body. In addition, in the heating chamber 1A, heating the precursor of a silicone rubber molded body allows volatilization of a low molecular weight compound from this precursor of a silicone rubber molded body.

The heating chamber 1A is provided with a sheathed heater 2 that heats the heating chamber 1A, and a cooling fan 6 that cools a control panel (not shown) in the heating chamber 1A.

In the example shown in FIG. 1, an outlet 1A_{X} of the heating chamber 1A communicates with an inlet 1B_{N} of the aging chamber 1B. The heated precursor of a silicone rubber molded body is transferred by the transfer unit 4, into the aging chamber 1B through inside the heating chamber 1A.

<Aging Chamber>

A configuration of the aging chamber 1B may be similar to that of the heating chamber 1A described above or the gas introducing chamber 1C described later. That is, the aging chamber 1B may have the unit 7 that externally introduces and discharges environmental gas, which is described later. In this aging chamber 1B, further heating is continuously performed on the precursor of a silicone rubber molded body that has been heated to crosslink a rubber raw material. Further, when the aging chamber 1B has the unit that externally introduces and discharges environmental gas, the environmental gas is introduced and discharged during heating.

In the example shown in FIG. 1, an outlet 1B_{X} of the aging chamber 1B communicates with an inlet 1C_{N} of the gas introducing chamber 1C. The heated precursor of a silicone rubber molded body is transferred by the transfer unit 4, into the gas introducing chamber 1C through the inside of the aging chamber 1B.

<Gas Introducing Chamber>

The gas introducing chamber has the unit 7 that introduces an environmental gas from outside the manufacturing apparatus 1 for a silicone rubber molded body and discharges. The unit 7 that externally introduces and discharges environmental gas is not particularly limited, and it is sufficient that the gas around the precursor of a silicone rubber molded body (the environmental gas in the chamber) can be externally introduced, and the environmental gas can be discharged to outside.

Specifically, in the example of FIG. 1, the gas introducing chamber 1C has, as the unit 7 that externally introduces and discharges the environmental gas, a unit 7A that externally introduces the environmental gas, and a unit 7B that discharges the environmental gas to outside. These cause external introduction and discharge of environmental gas.

In the example of FIG. 1, the unit 7B that discharges the environmental gas to outside causes the environmental gas to be discharged outside by an exhaust fan 70B. Specifically, the unit 7B that discharges the environmental gas to outside has the exhaust fan 70B and an exhaust duct 72B below the transfer unit 4 in the gas introducing chamber 1C.

The environmental gas in the gas introducing chamber 1C is exhausted by the exhaust fan 70B. The discarded gas passes through the exhaust duct 72B and is discharged to outside the manufacturing apparatus 1.

Meanwhile, by the unit 7A that externally introduces the environmental gas, the environmental gas externally introduced is blown to the roller 50 with a pressure fan 70A.

Specifically, in the example in FIG. 1, as the unit 7A that externally introduces the environmental gas, the pressure fan 70A blows the gas taken from a supply source (not shown) of an external gas, from above the gas introducing chamber 1C through a gas supply passage 72A. This causes introduction of the environmental gas externally introduced, into the gas introducing chamber 1C.

In this case, the pressure fan 70A desirably blows the environmental gas externally introduced, at an angle of 45 degrees or more with respect to a longitudinal direction of the precursor of a silicone rubber molded body. As long as the angle is as above, a direction of blowing is not limited, and for example, the blowing may be performed from above the precursor of a silicone rubber molded body as shown in FIG. 1.

The supply source of the external gas is not particularly limited as long as it can take gas from outside the manufacturing apparatus 1 for a silicone rubber molded body. Specifically, for example, a gas tank filled with compressed air, dry nitrogen, and the like can be mentioned. In a case of using compressed air, the air may be compressed to a high pressure by a publicly known compressor, and the generated compressed air or the like may be filled in a gas tank.

Further, a value (V/T), which is a value of a ratio of the total volume V (m³) of the precursor of a silicone rubber molded body to the capacity T (m³) of the chamber into and from which the environmental gas is externally introduced and discharged to outside is desirably within a range of 0.02 to 0.7. When V/T is 0.7 or less, introduction and discharge of environmental gas are sufficient, the volatilized low molecular weight compound does not accumulate in the environmental gas, and a low molecular weight compound is suitably volatilized from the precursor of a silicone rubber molded body. Further, V/T of 0.02 or more is desirable since this makes it possible to avoid turbulence caused by increased speed for introducing and discharging the environmental gas, thereby to enable uniform heating. In addition, introduction of the environmental gas is desirable from the viewpoint of thermal efficiency, and desirable because production cost can be lowered, since the inside of the chamber is not cooled as long as V/T is within the above range, even when a gas at a temperature lower than the temperature inside the chamber is introduced into the chamber.

In the gas introducing chamber 1C, a punching metal 8 may be provided as shown in FIG. 1 for the purpose of uniformly applying the introduced environmental gas to the roller 50. The pressure fan 70A is provided on the punching metal 8, and a heat-resistant filter 9 is provided under the punching metal 8. Such a configuration is desirable since the environmental gas introduced by the pressure fan 70A can be uniformly applied to the roller 50 by many small holes 8a of the punching metal 8. Further, by adjusting an angle at which the small hole 8a is drilled, the blowing angle of the environmental gas may be adjusted.

<Other Configurations>

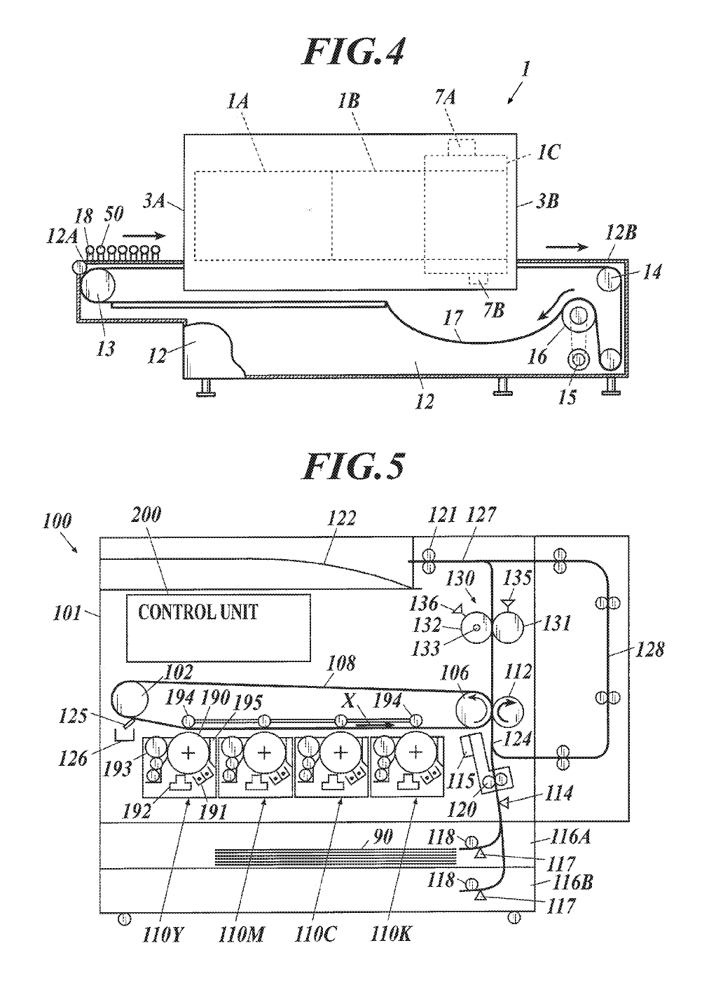

Other configurations of the manufacturing apparatus 1 for a silicone rubber molded body will be briefly described below with reference to FIG. 4 as well. FIG. 4 is an overall side view of the manufacturing apparatus 1 for a silicone rubber molded body shown in FIGS. 1 and 3.

The manufacturing apparatus 1 has an inlet shutter 3A at an inlet to introduce the roller 50, and an outlet shutter 3B at an outlet to discharge the roller 50. The transfer unit 4 has: a transfer frame 12 installed with chambers 1A to 1C; sprockets 13 and 14 respectively provided to an inlet table 12A and an outlet table 12B of the transfer frame 12, positioned on the inlet side and the outlet side; a driving sprocket 16; and a chain 17 driven by the driving sprocket 16 and the sprockets 13 and 14. The driving sprocket 16 is provided near the outlet table 12B and rotated by a driving motor 15.

Two combinations of the sprockets 13 and 14 with the chain 17 are provided in a lateral width direction of the transfer frame 12.

Between the pair of chains 17, a plurality of plates 19 are provided at equal intervals. These plates 19 cause convection of the environmental gas inside the chamber. At both ends of each plate 19, a pair of roller receivers 18 are respectively mounted. The roller receivers 18 have a V-shaped groove and carry the roller 50.

Such a configuration allows the transfer unit 4 to transfer the roller 50 in parallel to the advancing direction of the chain 17.

An operation of the transfer unit 4 and the like configured in such a way will be described. First, the driving sprocket 16 is rotated by the driving motor 15 to move the chain 17. A moving speed of the chain 17 is set according to a predetermined time required for passing through each chamber. For example, for the heating chamber 1A, it is set according to a time capable of crosslinking and curing a rubber raw material.

By being placed on the roller receiver 18, the precursor of a silicone rubber molded body is chain driven and sequentially introduced into the heating chamber 1A from the inlet shutter 3A, and sequentially transferred to each chamber. The precursor of a silicone rubber molded body is transferred to the next chamber after a lapse of a predetermined time, finally becomes a silicone rubber molded body via the gas introducing chamber 1C, and comes out from the outlet shutter 3B.

According to such an apparatus and a method, an amount of a low molecular weight compound can be easily reduced without washing the silicone rubber molded body.

[Electrophotographic Image Forming Apparatus]

Hereinafter, a schematic configuration of a color tandem type image forming apparatus 100 according to a desirable embodiment of the present invention will be described with reference to FIG. 5. This image forming apparatus is a multi-function machine having functions of a scanner, a copying machine, a printer, and the like, and is called a multi function peripheral or a multi function printer (MFP).

As shown in FIG. 5, the image forming apparatus 100 includes an annular intermediate transfer belt 108 that is wound around two rollers 102 and 106, and moves in a circumferential direction, at a substantially center in a main body casing 101.

In the two rollers 102 and 106, one roller 102 is disposed on a left side in the drawing, and the other roller 106 is disposed on a right side in the drawing. The intermediate transfer belt 108 is supported by these rollers 102 and 106 and rotationally driven in a direction of arrow X.

Below the intermediate transfer belt 108, sequentially from the left side of the drawing, image forming units 110Y, 110M, 110C, and 110K corresponding to toners of individual colors of yellow (Y), magenta (M), cyan (C), and black (K) are arranged side by side.

The individual image forming units 110Y, 110M, 110C, and 110K are configured similarly to each other except for a difference in toner colors handled by them.

For example, the yellow image forming unit 110Y is configured by integrating a photosensitive drum 190, a charging device 191, an exposure device 192, a developing device 193 that performs development using toner, and a cleaner device 195.

A primary transfer roller 194 is provided at a position opposed to the photosensitive drum 190 with the intermediate transfer belt 108 interposed therebetween.

At a time of image formation, firstly, a surface of the photosensitive drum 190 is uniformly charged by the charging device 191, and subsequently, the surface of the photosensitive drum 190 is exposed by the exposure device 192 to be formed with latent image there. Next, the latent image on the surface of the photosensitive drum 190 is developed by the developing device 193, to become a toner image. This toner image is transferred to the intermediate transfer belt 108 by voltage application between the photosensitive drum 190 and the primary transfer roller 194. Transfer residual toner on the surface of the photosensitive drum 190 is cleaned by the cleaner device 195.

As the intermediate transfer belt 108 moves in the direction of arrow X, toner images of four colors are formed to be superimposed as an output image on the intermediate transfer belt 108 by the image forming units 110Y, 110M, 110C, and 110K.

On a left side of the intermediate transfer belt 108, there is provided a cleaning device 125 that removes residual toner from the surface of the intermediate transfer belt 108, and a toner collection box 126 that collects the toner removed by the cleaning device 125.

On a right side of the intermediate transfer belt 108, a secondary transfer roller 112 is provided with a conveyance path 124 for paper interposed in between. A conveying roller 120 is provided at a position corresponding to an upstream side of the secondary transfer roller 112 in the conveyance path 124. An optical concentration sensor 115 that detects a toner pattern on the intermediate transfer belt 108 is provided.

A fixing device 130 that fixes toner on paper is provided at an upper right portion in the main body casing 101.

The fixing device 130 includes a pair of fixing rollers vertically extending with respect to a paper surface of FIG. 5. One of the fixing rollers is a heating roller 132 and the other is the pressurizing roller 131.

The heating roller 132 is heated by a heater 133 to a predetermined target temperature (e.g., a fixing temperature within a range of 180 to 200° C.). The pressurizing roller 131 is urged toward the heating roller 132 by a spring (not shown). This causes the pressurizing roller 131 and the heating roller 132 to form a nip portion for the fixation.

As the paper 90 transferred with the toner image passes through this nip portion, the toner image is fixed on the paper 90. Temperatures of the pressurizing roller 131 and the heating roller 132 are respectively detected by temperature sensors 135 and 136.

At a bottom of the main body casing 101, paper feeding cassettes 116A and 116B that accommodate the paper 90 are provided in two stages. FIG. 5 shows a state in which the paper 90 is accommodated in the paper feeding cassette 116A alone.

Each of the paper feeding cassettes 116A and 116B is provided with a paper feeding roller 118 that feeds paper, and a paper feed sensor 117 that detects the fed paper.

In the main body casing 101, there is provided a control unit 200 including a central processing unit (CPU) that controls an operation of the entire image forming apparatus.

At a time of image formation, under the control of the control unit 200, the paper 90 is fed one by one from the paper feeding cassette 116A to the conveyance path 124 by the paper feeding roller 118. The paper 90 fed to the conveyance path 124 is to be fed to a toner transferring position between the intermediate transfer belt 108 and the secondary transfer roller 112, by the conveying roller 120 in timing controlled by a registration sensor 114.

On the other hand, as described above, the toner images of the four colors are formed to be superimposed on the intermediate transfer belt 108 by the individual image forming units 110Y, 110M, 110C, and 110K, and the toner images of the four colors on the intermediate transfer belt 108 are transferred by the secondary transfer roller 112 onto the paper 90 fed to the toner transferring position.

The paper 90 transferred with the toner image is conveyed through the nip portion formed by the pressurizing roller 131 and the heating roller 132 of the fixing device 130, and subjected to heating and pressurization. This fixes the toner image on the paper 90.

Finally, the paper 90 fixed with the toner image is discharged to a paper discharging tray 122 provided on an upper surface of the main body casing 101, by a discharge roller 121 through a discharge path 127.

In the image forming apparatus 100, there is provided a switchback conveyance path 128 to feed the paper 90 to the toner transferring position again in a case of duplex printing.

As described above, the pressurizing roller 131 constitutes one of the fixing rollers, which is a silicone rubber roller in this case.

It is noted that the embodiments applicable with the present invention are not limited to the above-mentioned embodiments, and can be appropriately changed without departing from the gist of the present invention.

For example, in the manufacturing method and the manufacturing apparatus for a silicone rubber molded body according to the present invention, the heating chamber may also serve as the gas introducing chamber as described above.

That is, while curing the silicone rubber on the surface layer of the precursor of a silicone rubber molded body, the gas introducing chamber may reduce an amount of a low molecular weight compound.

Further, when the heating chamber also serves as the gas introducing chamber (that is, when there is provided the unit that externally introduces and discharges environmental gas), while the precursor of a silicone rubber molded body is heated in the heating chamber, the environmental gas may be externally introduced and discharged, in this heating chamber. This allows the process to be performed in a short time.

In this case, as a unit that externally introduces and discharges the environmental gas, the heating chamber can have the unit 7 that externally introduces and discharges the environmental gas similarly to the gas introducing chamber 1C shown in FIG. 1 above.

Further, the heating chamber may also serve as an aging chamber, and furthermore, the heating chamber may also serve as an aging chamber and a gas introducing chamber. In such a case, the manufacturing apparatus for a silicone rubber molded body according to the present invention may have one heating chamber 1A alone having a similar configuration to the gas introducing chamber 1C shown in FIG. 1 above.

In addition, it is also possible to perform a process in which the precursor of a silicone rubber molded body performs movement such as rotation in each chamber, to be uniformly blown with the environmental gas.

### EXAMPLE

Hereinafter, the present invention will be specifically described with reference to Examples, but the present invention is not limited thereto. In the Examples, while the expression “parts” or “%” is used, it means “parts by mass” or “mass %” unless otherwise specified.

First, a precursor of a silicone rubber molded body was prepared. Next, the precursor of a silicone rubber molded body was subjected to the process in Examples 1 to 8 and Comparative Example 1 as a heating process. Specific process of Examples 1 to 8 and Comparative Example 1 is as shown in Table I, that is, whether an environmental gas was externally introduced and discharged (“Introduction and discharge” in Table I), a speed for introducing and discharging the environmental gas (“Speed of introduction and discharge” in Table I), a type of the environmental gas to be introduced, and a moisture content (“Gas type” and “Moisture content” in Table I), the value (V/T) of a ratio of the total volume V (m³) of the precursor of a silicone rubber molded body to the capacity T (m³) of the chamber into and from which the environmental gas is externally introduced and discharged to outside, Asker C hardness of the silicone rubber (“Asker C hardness” in Table I), presence or absence of the gas introducing chamber (“Presence/absence of gas introducing chamber” in Table I), and an angle for blowing the environmental gas against a longitudinal direction of the precursor of a silicone rubber molded body (“Blowing angle” in Table I). Each process is as described below.

[Preparation of Precursor of Silicone Rubber Molded Body]

To 100 parts by mass of two-component room temperature curing type silicone rubber (trade name: KE-1602, manufactured by Shin-Etsu Chemical Co., Ltd.), 10 parts by mass of a curing agent (trade name: CAT-1602, manufactured by Shin-Etsu Chemical Co., Ltd.) was added, and mixing was thoroughly performed with an agitator to obtain a silicone rubber mixture C.

The silicone rubber mixture C was added with 15 parts by mass of expanded Expancel 461, and mixed with an agitator for 30 minutes to obtain a silicone rubber mixture D. Expancel 461 is a microballoon manufactured by Akzo Nobel N.V, having an outer shell that is a copolymer of vinylidene chloride and acrylonitrile, and is melted at 110° C. Unexpanded spherical diameter was 10 to 16 μm, and in this case, heating was performed at 100° C. for 10 minutes to obtain an expanded microballoon with a spherical diameter of 40 to 60 μm.

Apart from the preparation of the silicone rubber mixtures C and D, a core metal made of aluminum (length of 370 mm, diameter of 25 mm) was applied with an adhesive, covered with a paper tube having a diameter larger than the core metal by 15 mm with the core metal being in a center, and provided with a bottom lid.

Thereafter, the silicone rubber mixture C (not containing microballoons) was poured between the paper tube and the core metal, and the mixture was left to stand for a whole day and night at room temperature to complete curing. Thereafter, the paper tube was removed to form a solid rubber layer.

Thereafter, the silicone rubber mixture D (including microballoons) was applied to this solid rubber layer to a thickness of 100 μm, and left to stand for a whole day and night. Then, a surface was polished with a polisher, and there was formed a sponge rubber layer embedded with numerous microballoon of about 40 to 60 μm.

By such the process, there was obtained a precursor of a silicone rubber molded body (a roller for a copying machine, a surface length of rubber layer of 340 mm, see FIG. 2) having a two-layer structure of an outer layer of the sponge rubber and an inner layer of the solid rubber.

[Introduction and Discharge of Environmental Gas]

Introduction and discharge of environmental gas were performed in two cases. A gas introducing chamber is used in one case, and introduction and discharge were performed in a heating chamber in another case.

In each Example and Comparative Example, the gases to be introduced are as shown in Table I. Meanwhile, the compressed air is compressed normal atmosphere, which may be compressed by a compressor, or may be supplied from an air cylinder. Commercially available dry nitrogen can be used, which can be supplied, for example, using a nitrogen cylinder manufactured by Kanto Chemical. Further, an angle for blowing the environmental gas externally introduced is an angle with respect to a longitudinal direction of the precursor of a silicone rubber molded body. This angle was a value described in “Blowing angle” in Table I. It is noted that this angle was measured for all the precursors of a silicone rubber molded body to which environmental gas was blown in the chamber, and the average value thereof was recorded in Table I.

Moreover, a total volume V of the precursor of a silicone rubber molded body is calculated by calculating a volume of a single precursor of a silicone rubber molded body from a radius and a length, and calculating the product of the volume of the single precursor and an average number of precursors existing in the chamber that is introduced and discharged with the environmental gas.

<Case with Gas Introducing Chamber>

First, the precursor of a silicone rubber molded body was transferred to the aging chamber.

In the aging chamber, the precursor was heated to 200° C. and left to stand for 1 hour.

In the aging chamber, the precursor of a silicone rubber molded body was gradually moved, transferred from one end to another end over 1 hour, and introduced into the gas introducing chamber connected with the aging chamber. It is noted that the value (V/T) of a ratio of the total volume V (m³) of the precursor of a silicone rubber molded body to the capacity T (m³) of the gas introducing chamber was as shown in Table I.

While the precursor was heated to 200° C. in the gas introducing chamber, a process of reducing a low molecular weight compound was performed with a speed for introducing and discharging the environmental gas set as shown in Table I, and a silicone rubber molded body was manufactured. A type of the environmental gas and a moisture content are as shown in Table I.

<Case without Gas Introducing Chamber Separately Provided (“Absence” of Gas Introducing Chamber in Table I)>

The heating chamber also serves as a gas introducing chamber. Specifically, the precursor was heated to 200° C. in the heating chamber, left to stand for 1 hour to be subjected to aging. It is noted that the value (V/T) of a ratio of the total volume V (m³) of the precursor of a silicone rubber molded body to the capacity T (m³) of the gas introducing chamber (heating chamber in this case) is as shown in Table I.

Thereafter, the environmental gas was externally introduced and discharged, in the heating chamber. A speed for introducing and discharging the environmental gas is as shown in Table I.

A process of reducing a low molecular weight compound was performed with the speed for introducing and discharging the environmental gas set as shown in Table I, and a silicone rubber molded body was manufactured. A type of the environmental gas and a moisture content are as shown in Table I.

[Removal of Silicone Rubber Molded Body]

After the process of reducing a low molecular weight compound was performed, the silicone rubber molded body discharged from each chamber was taken out.

Hardness of each silicone rubber molded body was measured with an Asker C type hardness tester. Hardness was as shown in Table I.

[Evaluation]

Printing was performed in a closed space that is hermetically sealed with a copying machine that is equipped with the silicone rubber molded body produced as described above, and the atmosphere was collected and analyzed. Specifically, the silicone rubber molded body of Examples 1 to 8 and Comparative Example 1 was incorporated in a fixing device of bizhub C308 manufactured by Konica Minolta Inc. Then, this modified machine was placed in a chamber that is made of SUS and has a volume of 5 m³, and ventilation was performed at an air flow rate of 15 m³/h. After ventilation for about 1 hour, printing was performed for 10 minutes, and volatile substances generated from an inside of the machine were sampled by a Tenax tube at an amount of 10 mL/min. After that, sampling was continued for about 20 minutes even after the printing was stopped. Then, the sampled Tenax tube was desorbed with a thermal desorption device, and measurement was performed with GC-MS to calculate a generation amount of siloxane gas. This amount was evaluated as an amount of a low molecular weight compound remaining in the silicone rubber.

TABLE 1

| | | SPEED OF | | | | |
|---|---|---|---|---|---|---|
| | INTRODUCTION | INTRODUCTION | | MOISTURE | | |
| | AND | AND DISCHARGE | | CONTENT | | |
| | DISCHARGE | [m³/min] | GAS TYPE | [mass %] | V/T | ROLLER TYPE |
| EXAMPLE 1 | YES | 0.4 × V | COMPRESSED | 5 | 0.10 | SILICONE RUBBER |
| | | | AIR | | | ROLLER |
| EXAMPLE 2 | YES | 96.0 × V | COMPRESSED | 5 | 0.10 | SILICONE RUBBER |
| | | | AIR | | | ROLLER |
| EXAMPLE 3 | YES | 0.4 × V | DRY NITROGEN | 5 | 0.10 | SILICONE RUBBER |
| | | | | | | ROLLER |
| EXAMPLE 4 | YES | 0.4 × V | COMPRESSED | 6 | 0.10 | SILICONE RUBBER |
| | | | AIR | | | ROLLER |
| EXAMPLE 5 | YES | 0.4 × V | COMPRESSED | 5 | 0.75 | SILICONE RUBBER |
| | | | AIR | | | ROLLER |
| EXAMPLE 6 | YES | 0.4 × V | COMPRESSED | 5 | 0.10 | SILICONE RUBBER |
| | | | AIR | | | ROLLER |
| EXAMPLE 7 | YES | 0.4 × V | COMPRESSED | 5 | 0.10 | SILICONE RUBBER |
| | | | AIR | | | ROLLER |
| EXAMPLE 8 | YES | 0.4 × V | COMPRESSED | 5 | 0.10 | SILICONE RUBBER |
| | | | AIR | | | ROLLER |
| COMPARATIVE | NO | — | — | — | 0.10 | SILICONE RUBBER |
| EXAMPLE 1 | | | | | | ROLLER |

| | | PRESENCE/ | | | |
|---|---|---|---|---|---|
| | | ABSENCE | | | |
| | ASKER C | OF GAS | BLOWING | RESIDUAL | |
| | HARDNESS | INTRODUCING | ANGLE | AMOUNT | |
| | [°] | CHAMBER | [degree] | [mass %] | REMARKS |
| EXAMPLE 1 | 35 | PRESENT | 80 | 0.4 | EXAMPLE |
| EXAMPLE 2 | 35 | PRESENT | 80 | 0.02 | EXAMPLE |
| EXAMPLE 3 | 35 | PRESENT | 80 | 0.5 | EXAMPLE |
| EXAMPLE 4 | 35 | PRESENT | 80 | 0.9 | EXAMPLE |
| EXAMPLE 5 | 35 | PRESENT | 80 | 0.6 | EXAMPLE |
| EXAMPLE 6 | 70 | PRESENT | 80 | 1.2 | EXAMPLE |
| EXAMPLE 7 | 35 | ABSENT | 80 | 0.95 | EXAMPLE |
| EXAMPLE 8 | 35 | PRESENT | 43 | 1.4 | EXAMPLE |
| COMPARATIVE | 35 | ABSENT | — | 20.0 | COMPARATIVE |
| EXAMPLE 1 | | | | | EXAMPLE |

(Summary)

Table I has shown that, according to the present invention, it is possible to provide a manufacturing method for a silicone rubber molded body, capable of reducing an amount of a low molecular weight compound remaining in silicone rubber, to reduce an amount of a low molecular weight compound to be volatilized in use as a product.

Specifically, it is shown that the amount of the low molecular weight compound remaining in the silicone rubber is sufficiently reduced in Examples 1 to 8 (i.e., the residual amount is reduced to less than 1.5 mass %), enabling reduction of the amount of the low molecular weight compound to be volatilized in use as a product, as a result.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese patent application No. 2017-039524, filed on Mar. 2, 2017, is incorporated herein by reference in its entirety.

What is claimed is:

1. A manufacturing method for a silicone rubber molded body that is to be used in an electrophotographic image forming apparatus, the manufacturing method comprising:
a heating process of a precursor of a silicone rubber molded body, wherein
the heating process includes heating the precursor of a silicone rubber molded body and externally introducing an environmental gas and discharging the environmental gas to outside, to reduce an amount of a low molecular weight compound remaining in the precursor of a silicone rubber molded body.

2. The manufacturing method for a silicone rubber molded body according to claim 1, wherein
in the heating process,
after heating of the precursor of a silicone rubber molded body in a heating chamber,
the environmental gas is externally introduced and discharged to outside, in the heating chamber.

3. The manufacturing method for a silicone rubber molded body according to claim 1, wherein
in the heating process,
after heating of the precursor of a silicone rubber molded body in a heating chamber,
and after moving the heated precursor of a silicone rubber molded body from the heating chamber to a gas introducing chamber, the environmental gas is externally introduced into the gas introducing chamber and discharged to outside.

4. The manufacturing method for a silicone rubber molded body according to claim 1, wherein when a total volume of the precursor of a silicone rubber molded body is defined as V (m³), a speed for externally introducing the environmental gas and discharging the environmental gas to outside is within a range of 0.3×V to 100×V (m³/min).

5. The manufacturing method for a silicone rubber molded body according to claim 1, wherein the silicone rubber molded body is a fixing roller or a fixing belt to be used in a fixing unit.

6. The manufacturing method for a silicone rubber molded body according to claim 1, wherein the environmental gas externally introduced is compressed air or dry nitrogen having a moisture content of 5 mass % or less.

7. The manufacturing method for a silicone rubber molded body according to claim 1, wherein the environmental gas externally introduced is blown at an angle of 45 degrees or more with respect to a longitudinal direction of the precursor of a silicone rubber molded body.

8. The manufacturing method for a silicone rubber molded body according to claim 1, wherein a value (V/T) of a ratio of a total volume V (m³) of the precursor of a silicone rubber molded body to a capacity T (m³) of a chamber into and from which the environmental gas is externally introduced and discharged to outside is within a range of 0.02 to 0.7.

9. The manufacturing method for a silicone rubber molded body according to claim 1, wherein
the silicone rubber molded body is a rubber roller obtained by coating an outer layer of a core metal with silicone rubber,
and Asker C hardness of the silicone rubber on the core metal is within a range of 30 to 60°.

10. A manufacturing apparatus for a silicone rubber molded body that is to be used in an electrophotographic image forming apparatus, the manufacturing apparatus comprising:
a heating chamber that heats a precursor of a silicone rubber molded body, wherein
the heating chamber has a unit that introduces an environmental gas from outside the manufacturing apparatus for a silicone rubber molded body and discharges the environmental gas to outside.

11. A manufacturing apparatus for a silicone rubber molded body that is to be used in an electrophotographic image forming apparatus, the manufacturing apparatus comprising:
a heating chamber; and
a gas introducing chamber to which a precursor of a silicone rubber molded body is transferred from the heating chamber, wherein
the heating chamber heats the precursor of a silicone rubber molded body, and
the gas introducing chamber has a unit that introduces an environmental gas from outside the manufacturing apparatus for a silicone rubber molded body and discharges the environmental gas to outside.
